(19) United States
(12) Patent Application Publication
(10) Pub. No.: US 2017/0090207 A1
(43) Pub. Date: Mar. 30, 2017

(54) STEREOSCOPIC VIEWING APPARATUS

(71) Applicant: Kevin P. Parker, Berkeley, CA (US)

(72) Inventor: Kevin P. Parker, Berkeley, CA (US)

(21) Appl. No.: 14/868,312

(22) Filed: Sep. 28, 2015

(51) Int. Cl. G02B 27/22; H04M 1/05; G06T 19/00; H04N 13/04; G06F 3/01

(52) U.S. Cl. CPC G02B 27/2242; H04N 13/044; G06F 3/012; G06T 19/006; H04M 1/05

(57) ABSTRACT

A stereoscopic viewing apparatus having a housing and left and right optical lenses which are secured within left and right interior portions of the housing. A SmartPhone support positions the phone so that left and right image regions of the phone display are disposed along principal axis of the left and right lenses. The support includes left and right phone support members disposed in the respective left and right interior housing portions with both being movable between a retracted position to accommodate relatively large phones and an extended position towards one another to accommodate relatively small phones.

### BACKGROUND OF THE INVENTION

1. Field of the Invention

The present invention relates generally to optical viewing devices and, in particular, to stereoscopic viewing devices for use with display apparatus of varying dimensions such as cellular telephones of the type commonly referred to as SmartPhones.

2. Description of Related Art

Stereoscopic viewing apparatus are well known in the art. Referring now to the drawings, FIGS. 1 and 2 are two views a conventional handheld stereoscopic viewing apparatus, depicted generally by the numeral 20. As will be explained later in greater detail, apparatus 20 operates in conjunction with a suitably programmed conventional portable cellular telephone commonly referred to as a SmartPhone (sometimes generally referred to herein as a display apparatus). Viewing apparatus 20 and the SmartPhone operate together to provide a virtual reality (“VR”) experience which is relatively advanced, particularly when considering the potential low cost of viewing apparatus 20 which can be used with most existing modern SmartPhones.

A large variety of software, primarily in the form of mobile apps, can be readily downloaded from the internet onto a user's Smartphone to enable the phone to generate images that provide a Virtual Reality experience. One popular app is called Google Cardboard™ and is available on Apple's on line store at apple.com. FIG. 4 depicts an exemplary screen shot of a programmed SmartPhone display which includes a left (from a viewer's perspective) image region 44L and a right image region 44R. Also shown is image separation icon 46B and menu icon 46A. The two separate images 46L and 46R are of the same scene but are offset from one another. The viewing apparatus 20 functions to project the two images onto the respective left and right eyes of the viewer. As is well known, the two dimensional (2D) images are combined in the brain to produce the illusion of a single three dimensional (3D) image.

The majority of modern SmartPhones, such as those of the Apple iPhone® series include various internal sensors such as accelerometers, magnetometers and gyroscopes. These sensors can be used to detect rotational movement of the phone about all three axes. Further, the programmed image pairs, such as those of FIG. 4, are taken from all 360 degrees of the object. Thus, when the programmed phone is installed in the viewing apparatus 20 and the apparatus is positioned over the viewer's eyes, the phone sensors are able to detect rotational movement of the user's head and thereby control the generation of appropriate image pairs. In this manner, the user is able to observe the image object from any direction in 3D using natural head movements. Thus, the user is able to enjoy a VR experience.

Returning to the drawings, viewing apparatus 20 includes a housing 22 which, along with many other of the viewer components, can be fabricated from cardboard or other similar forms of semi-rigid paper. A front cut-out in the housing 22, with the outer edge preferably being covered in part by a soft cushion 40, is adapted to conform to a user's face. A pair of bi-convex lenses 44L and 44R are mounted on a lens support panel 42 secured within the housing. The lenses are preferably positioned near the user's eyes when the handheld viewing device is in operation. Lenses having a diameter of 33.5 mm and a focal length of 76 mm have be found suitable for this application. Lenses 44L and 44R, which are readily available from many sources at a relatively low cost, are positioned relative to a SmartPhone screen installed on the viewing device a distance equal to, or slightly less than, the focal length of the lenses. Thus, when so positioned the lenses provide a degree of image magnification and further place the virtual image of the screen near infinity so as to minimize eyestrain. Lenses 44L and 44R may be individually secured on panel 42 by way of screw mounts so that the position of each lens relative to the user's eyes can be individually adjusted to compensate for eyesight differences.

Viewing apparatus 20 preferably includes some mechanism for controlling operation of the SmartPhone while the viewing apparatus is positioned over the viewer's face. In the present example, the touch screen function of the SmartPhone is used as will be described. The interior of housing 22 includes a partition 34 (FIG. 2) disposed intermediate the lenses 44L and 44R. Partition 34 includes an extension in the form of an actuator arm 28. Arm 28 together with partition 34 are pivotally mounted within the housing so as to be movable between a retracted position as depicted in FIG. 2 and an actuating position (not depicted). When a user button 28A is depressed, a screen contactor 28B pivots forward to contact the SmartPhone screen. A spring (not depicted) operates to return the arm 28 and partition 34 to the retracted position after screen actuation is completed when the user releases button 28A. When in the retracted position, partition 34 and arm 28 limit light from the right image region 46R (FIG. 4) of SmartPhone reaching the user's left eye and limit light from the left image region 46L reaching the user's right eye so as to enhance the 3D effect.

Pivotable arm 28 is connected to actuator button 28A which extends through an opening in housing 22 to provide access to the button. An electrically conductive path is created from the user's finger by way of button 28A to display contactor 28B so that a conventional capacitive/conductive touch screen can detect the presence of contactor 28B when it is forced against the screen. Another common alternative approach to screen actuation can be used in the event the SmartPhone includes a magnetometer. A small movable magnet is mounted on housing 22 near the SmartPhone which can be manually toggled between two positions. This change in position can be detected by the SmartPhone magnetometer and used to control phone operation in much the same manner as display contactor 28B.

As can best be seen in FIGS. 2 and 3, housing 22 includes a back panel 24 which can be opened to receive a SmartPhone 30S (shown in phantom in FIG. 3) and closed to secure the SmartPhone in place. Back panel 24 is connected to the lower portion of the housing 22 by a back panel bottom segment 24B. A folding line 29B is formed in the back panel 24 by scoring the panel to facilitate folding. A top panel segment 24A is provided to hold the closed panel in place. Segment 24A is separated from back panel 24 by a fold line 29B created by scoring. One half 32A of a loop and hook fastener is secured at an appropriate location on the top of housing 22, with the second half 32B of the fastener being secured to the top panel segment 24A. A foam layer 38 is sandwiched between the back panel 24 and a panel member 36, with the foam layer becoming compressed when a SmartPhone 30S is installed so as to apply a holding force against the back of the phone by way of panel member 36.

The above-noted Google Cardboard app allows information regarding the construction of the viewing apparatus 20, including lens specifications and lens spacing from the phone screen, to be readily communicated to the SmartPhone using a machine readable code such as the well known QR™ code preferably printed on the outside of housing 22. Prior to installation of the SmartPhone in the viewing apparatus 20, the phone is prompted to scan the code. The phone then operates to automatically optimize the display images for the particular characteristics of the viewing apparatus 20.

Display apparatus supports 48A and 48B, are disposed within housing 22 and secured to the upper inner surface of the housing by respective supports 49A and 49B. A central display apparatus support 48C is disposed adjacent actuator arm 28 and is fixed in place. FIG. 5 a schematic representation of housing 22 showing locations 48A, 48B and 48C on the housing that assist in supporting a SmartPhone at the top of the phone. A relatively large SmartPhone will engage all three supports 48A, 48B and 48C and thus will be relatively well supported. However, in FIG. 5, a relatively small SmartPhone 30S is depicted, with the phone and housing being drawn approximately to scale. In this example, phone phantom image 30S size corresponds to a relatively small phone such as the iPhone 5s® which measures about 124 mm in length and 59 mm in width, with the housing 22 measuring approximately 150 mm wide and 75 mm high. As can be seen in FIG. 5, points 48A and 48B on the housing are not in a position to engage the display side of relatively small SmartPhone 30S. Only support 48C is positioned to engage the upper portion of the phone. Thus, SmartPhone 30S will not always be adequately supported when held in place by the back panel 24.

It is preferable that the above-noted shortcomings of the prior art viewing apparatus 20 not be addressed simply by reducing the size of housing 22. If that approach were taken, the viewing apparatus would then be unable to easily accommodate larger SmartPhones such as the iPhone 6+® which measures approximately 158 mm in length and 78 mm in width.

There is a need for a stereographic viewing apparatus providing the same general viewing properties of the above-described prior art viewing apparatus but which is more capable of easily accommodating a wider range of SmartPhone sizes. The present invention successfully addresses this and other shortcomings the prior art as will become apparent to those skilled on the art from a reading of the following Detailed Description of the Invention together with the drawings.

### SUMMARY OF THE INVENTION

A stereoscopic viewing apparatus is disclosed which includes a housing along with left and right optical lenses which are secured within left and right interior portions of the housing. A support for a display apparatus, such as a SmartPhone, is provided which is configured to secure the display apparatus with respect to the housing so that a left image region of the display apparatus is disposed along a principal axis of the left lens and a right image region of the display apparatus is disposed along a principal axis of the right lens. The display apparatus support includes a left and right support members, both of which are movable between a retracted position away from a center of the housing interior and an extended position towards the center of the housing interior. The display apparatus support is configured such that a spacing intermediate the left and right support members changes by at least 10 mm when the left and right support members are both moved between the retracted and the extended positions.

### BRIEF DESCRIPTION OF THE DRAWINGS

FIG. 1 is a perspective front view of a conventional stereoscopic viewing apparatus for use with a suitably programmed cellular telephone (“SmartPhone”) to provide virtual reality (“VR”) effects.

FIG. 2 is a perspective rear view of the conventional stereoscopic viewing apparatus of FIG. 1 showing a hinged rear cover in an open position which operates to secure a SmartPhone to the apparatus so that SmartPhone images can be viewed.

FIG. 3 is side partial view of the conventional stereoscopic viewing apparatus of FIGS. 1 and 2 showing a SmartPhone in phantom secured within the apparatus.

FIG. 4 is a front view of a conventional SmartPhone screen, with the SmartPhone being suitably programmed in a conventional manner to provide stereo image pairs for simulating three dimensional (3D) and certain VR effects.

FIG. 5 is a schematic rear view of the conventional stereoscopic viewing apparatus of FIGS. 1 and 2 showing various components for supporting a relatively small SmartPhone shown in phantom and illustrating the shortcomings in properly supporting the Smart Phone.

FIG. 6 is a rear perspective view of a stereoscopic viewing apparatus in accordance with one embodiment of the present invention showing the left and right SmartPhone support members both disposed in a retracted position to accommodate a relatively large smart phone.

FIG. 7 is a rear perspective view of the stereoscopic viewing apparatus of FIG. 6 showing the left and right SmartPhone support members both disposed in an extended position to accommodate a relatively small SmartPhone.

FIG. 8 is a plan view of one of the two SmartPhone support members prior to installation in the stereoscopic viewing apparatus housing of FIGS. 6 and 7.

FIG. 9 is a schematic cross-sectional side view of one of the two SmartPhone support members of FIGS. 6 and 7 shown in a retracted position and also in an extended position depicted in phantom.

FIGS. 10A, 10B and 10C show details of one of the four living hinge mechanisms of the SmartPhone support members of FIGS. 6 and 7 where the support member is in a stable extended position (FIG. 10C), a stable retracted position (FIG. 10A) and an unstable position (FIG. 10B) intermediate the extended and retracted positions.

FIG. 11 is a schematic rear view of the stereoscopic viewing apparatus of FIGS. 6 and 7 showing the SmartPhone support members in an extended position to accommodate a relatively small SmartPhone (shown in phantom).

FIG. 12 is a schematic rear view of the stereoscopic viewing apparatus of FIGS. 6 and 7 showing the SmartPhone support members in a retracted position to accommodate a relatively large SmartPhone (shown in phantom).

### DETAILED DESCRIPTION OF THE INVENTION

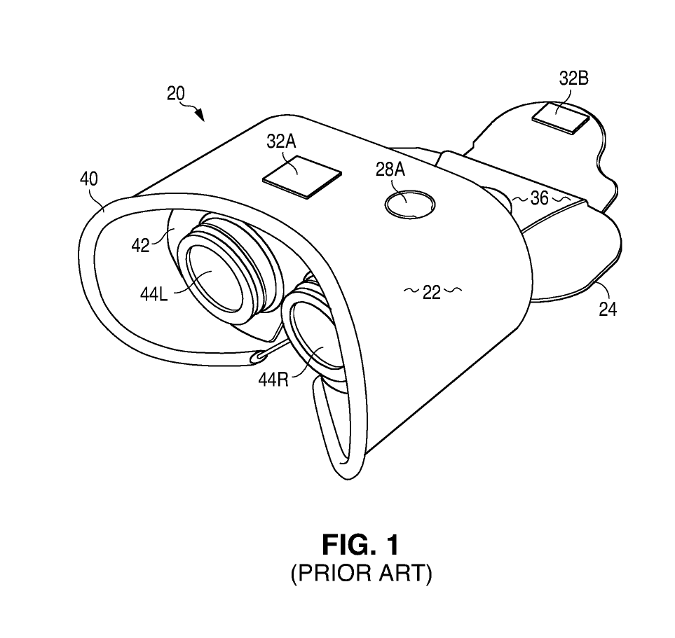

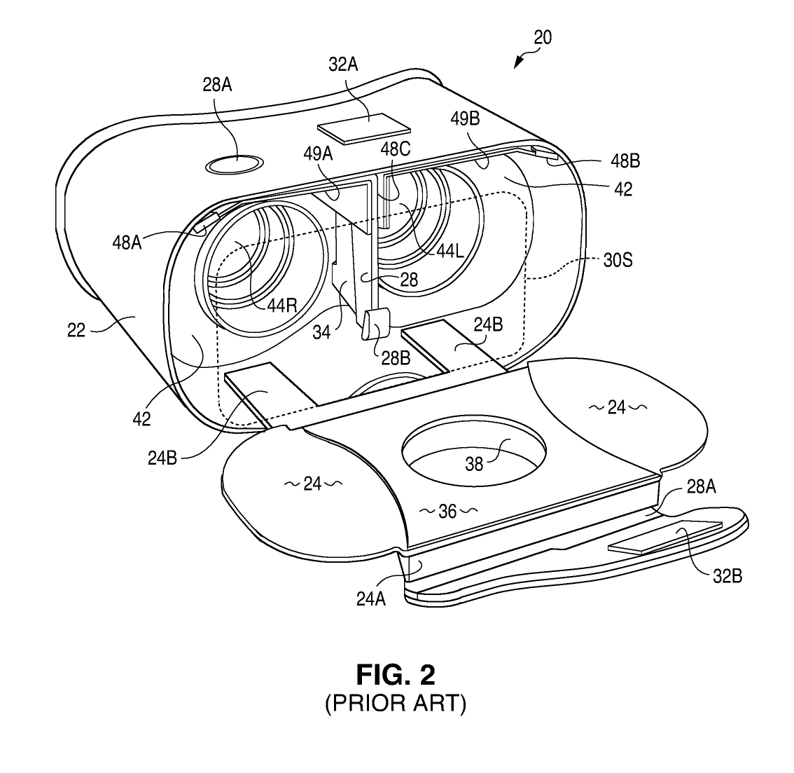

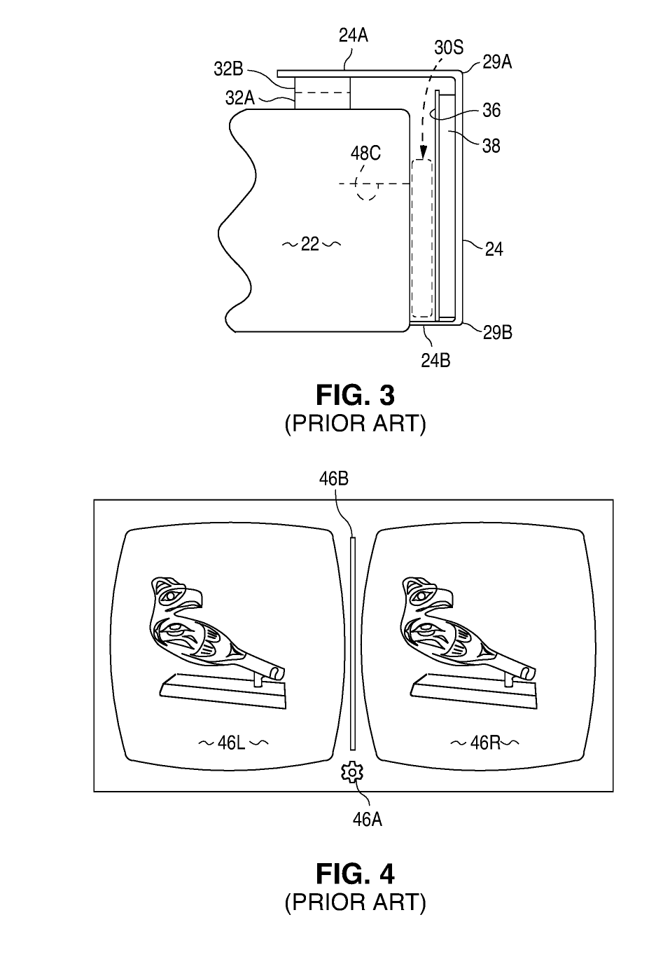

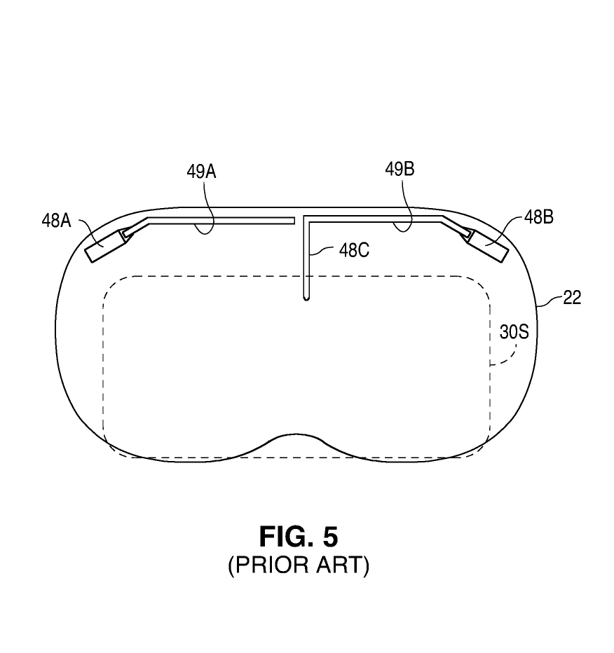

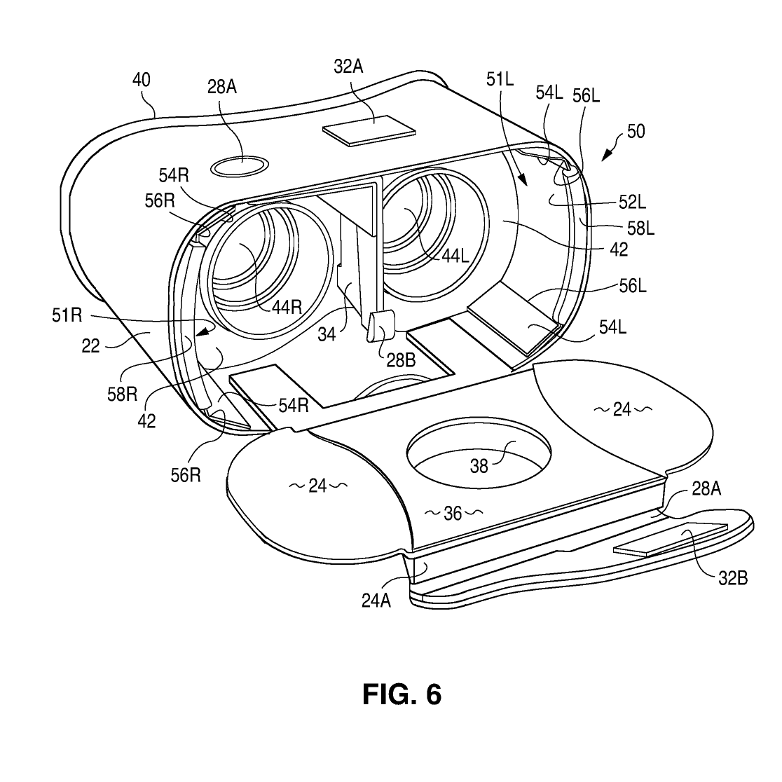

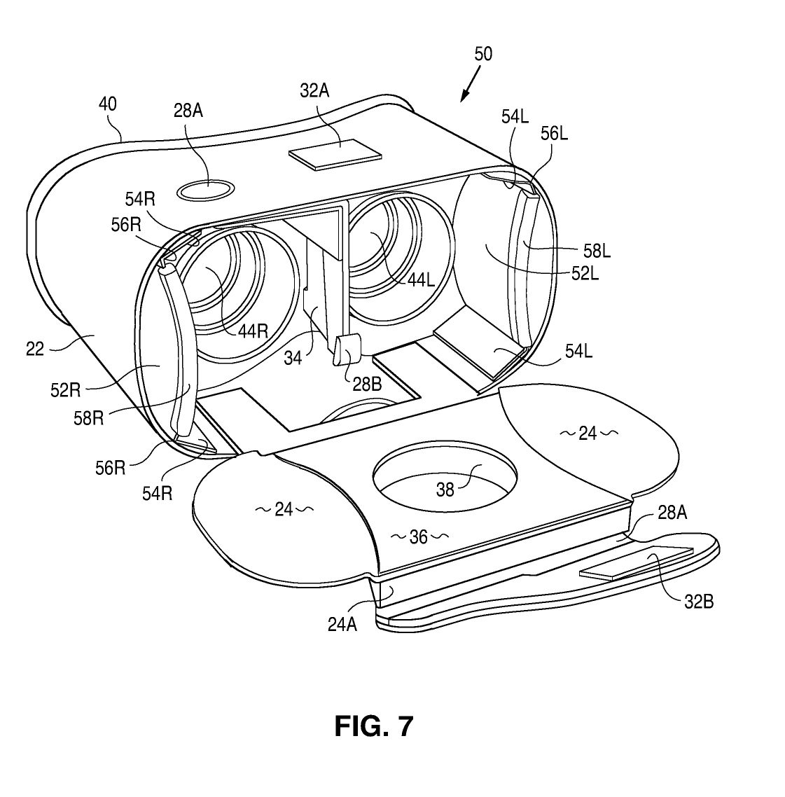

Referring again to the drawings, FIGS. 6 and 7 depict one embodiment, generally designated by the numeral 50, of the present invention. Common features of the FIGS. 6 and 7 embodiment and the prior art embodiment of FIGS. 1 and 2 are designated with common numerals. The housing 22 dimensions of FIGS. 6 and 7 are similar to that of the housing 22 of FIGS. 1 and 2. A SmartPhone support, sometimes referred herein as a display support apparatus, is provided with right and left opposing support members, generally designated by numerals 51R and 51L, respectively. Support members 51R and 51L are secured within housing 22 on respective right and left inner walls of the housing.

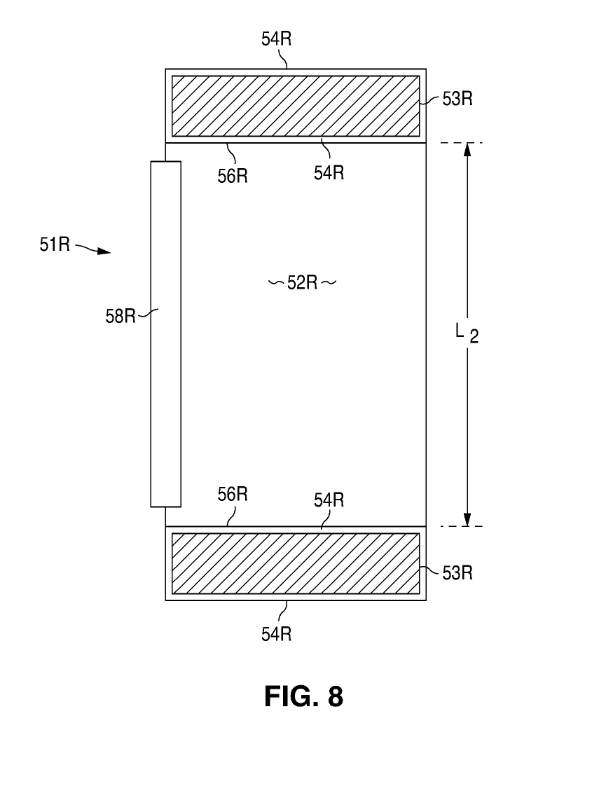

FIG. 8 shows details regarding right support member 51R, with left support member 51L being of similar construction. Support member 51R, which is shown in a top view, is relatively flat prior to installation within housing 22. Support member 51R preferably includes a thin flat plastic sheet or membrane 52R, along with two contact regions 54R disposed at opposite ends of the membrane. The central membrane 52R and the two contact regions 54R are all preferably formed from a single sheet of plastic. A high density polyethylene plastic sheet about 0.51 mm thick has been found suitable for this purpose. The two opposite contact regions 54R are used to secure the right support member 51R on the interior wall of the right side of housing. Since the two opposite contact regions 54R of support member 51R are made of the same semi-rigid plastic as the central membrane 52R, member 51R does not readily conform to the curved interior surface of housing 22. Accordingly, a pair of malleable supports, typically in the form of relatively thin foam pads 53R, are secured on contact regions 54R by an adhesive or the like. In addition, a rubber cushion 58R is positioned over an edge of membrane 52R which contacts the screen side of the SmartPhone when the phone is installed.

As will be described, in operation the central membrane 52R will pivot between two positions, with the two contact regions 54R remaining stationary (except for a possible slight flexing of housing 22). In order to facilitate pivoting movement between elements 52R and 54R, a hinge mechanism 56R is provided at each of the two interfaces of the central membrane 52R and the end contact regions 54R. Both of these hinge mechanisms 56R are preferably implemented as so-called living hinges. As is commonly known, a living hinge is a form of flexure bearing which is usually made from the same material as the two members the hinge connects, elements 52R and 54R in this case. The material intermediate the two connected elements is typically thinned or cut to allow the connected elements to bend relative to one another. As will be described later, in the present case each hinge mechanism 56R has a narrow thinned out region in the form of a “V” shaped groove so as to accurately define the points about which the right support member 51R pivots. This is also true regarding left support member 51L.

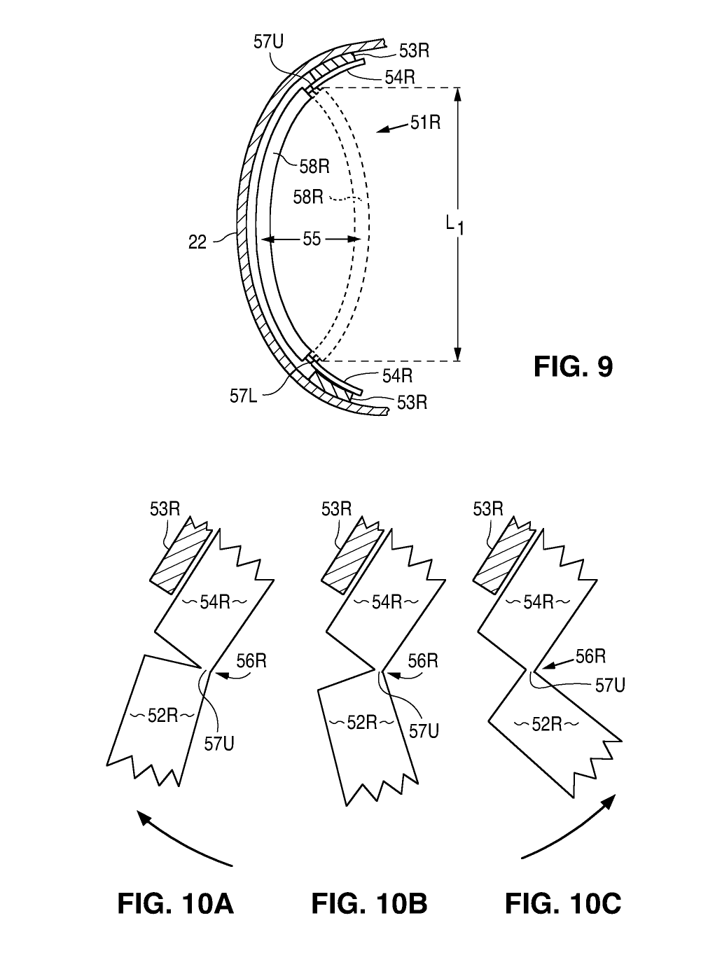

FIG. 9 is a schematic representation of one of the display apparatus (SmartPhone) support members, right support member 51R in this example, installed within housing 22. The drawing is not to scale, with the curvature of housing 22 being somewhat exaggerated for purposes of illustration. The display apparatus support member 51R is installed by positioning the member on the right curved inner wall of housing 22 and then securing the member in place by way of the two flexible pads 53R located at opposite ends of the support 51R using a suitable adhesive. In this position membrane 52R is curved as depicted in FIG. 9 to conform to the inner curvature of housing 22.

The pivot points defined by hinge mechanisms 56R are designated by 57U and 57L in FIG. 9, with the hinge mechanisms themselves not being designated in that figure. The direct line spacing between the pivot points is represented by L1. The spacing between the pivot points (not designated) in FIG. 8 along the surface of flat membrane 52R is represented by L2. Since 52R is curved when installed, the straight line spacing L1 in somewhat smaller than the length L2 along membrane 52R.

With the membrane 52R positioned at or near the inner wall of housing 22 as depicted in FIG. 9, the display apparatus support member 51R is in a retracted position. The display support member 51R can be moved to an extended position as shown in phantom in FIG. 9 by manually grasping the cushion 58R and moving the membrane 52R away from the housing inner wall towards the center of the housing. As the membrane 52R starts to move away from the retracted position, this external force will cause the membrane to start to compress since the membrane length L2 between the pivot points is greater the direct line distance L1. The compressive force will cause the membrane 52R to distort thereby causing the movement to be resisted. Further manual displacement of membrane 52R will result in a greater resisting force until the membrane begins to pass directly between and then slightly past the pivot points 57U and 57L. At that point the membrane 52R is free to expand, releasing energy stored by the membrane. This released energy forces membrane 52R to snap from this near center position to the extended position shown in phantom without further application of an external force by the user.

This process is reversed when the user manually forces the membrane 52R back from the extended position towards the retracted position. Once again, an external force must be applied until the membrane is moved between and slightly past the pivot points 57U and 57L. At that point the energy stored in membrane 52R forces the support 51R to snap into the retracted position without the presence of any external force. Thus, the support member 51R has only two stable states, one in the retracted position and the other in the extended position. The intermediate position is not stable. This general class of bi-stable apparatus is sometimes referred to in the art as an over-center apparatus.

Note that since housing 22 can be fabricated from light weight materials, the distance L1 (FIG. 9) may be altered as the housing flexes when the support member 51R is moved between the retracted and extended states. This housing movement, if present, will tend to supplement the storage and release of energy of membrane 52R and thereby enhance the bi-stable operation provided the housing is not too flexible. Note that the display apparatus supports members 51L and 51R are configured so that cushions 58L and 58R mounted on the respective membranes 52L and 52R define a common plane. This common plane will approximately coincide with the plane defined by the front side of a SmartPhone when the phone is installed in the subject stereoscopic viewing apparatus 50 thus providing stable support for the phone.

FIGS. 10A, 10B and 10C show further details of hinge mechanism 56R, one of the four similar hinge mechanisms utilized in the left and right support members 51L and 51R. As previously described, the hinge mechanisms are preferably formed by creating a “V” shaped groove in the plastic sheet that makes up membrane 52R and the two contact members 54R. The groove preferably extends through least a majority of the thickness of the plastic sheet.

As shown in FIGS. 10A, 10B and 10C, contact member 54R is secured to the inner wall of housing 22 (not depicted) by way of spacer 53R and thus member 54R remains fixed in place. FIG. 10A shows details of hinge mechanism 56R of the right display apparatus support member (not designated) when the support member is in the retracted position, one of the two stable positions. As previously described, when the support members 51L and 51R are in the retracted position, the corresponding membrane, such as membrane 52R of FIG. 10A, is positioned against or near the inner wall of the housing. The location of the vertex of the “V” groove defines the point 57U about which hinge mechanism 56R pivots. The width of the “V” groove at the groove mouth should be sufficiently large such that the walls of the groove do not contact one another and thereby limit movement when the hinge mechanism is at a minimum angle position of FIG. 10A. FIG. 12 is schematic view of the left and right display apparatus support members 51L and 51R in the retracted position of FIG. 10A.

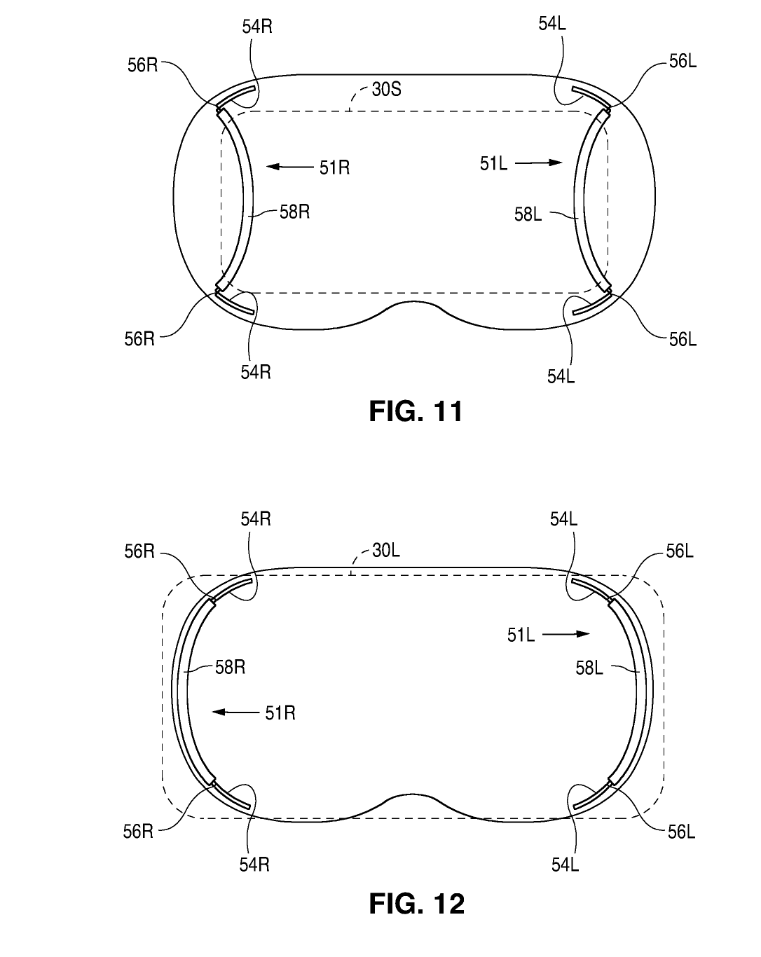

FIG. 10C depicts the state of hinge mechanism 56R when the display apparatus support member 51R is in the extended position, the second stable state. At this point, hinge mechanism 56R is at a maximum angle position. FIG. 11 is schematic view of the left and right display apparatus supports members 51L and 51R when the members are in the extended positions of FIG. 10C. FIG. 10B depicts an intermediate and thus unstable state. Depending upon the exact location of membrane 52A in FIG. 10B relative to the respective upper and lower pivots points 57U and 57L, the display apparatus support member 51R will move towards either the retracted state of FIG. 10A or the extended state of FIG. 10C without application of an external force by a user.

Returning to FIG. 11, the two display apparatus support members 51R and 51L are both moved to the extended position to accommodate relatively small display devices such as the iPhone 5s® depicted in phantom in the drawing as 30S and which measures 124 mm by 59 mm. A user centers the phone 30S over the extended support members 51L and 51R as depicted in FIG. 11 and which is drawn approximately to scale. The common plane defined by the two extended support members 51L and 51R engages the front of the phone so that the phone is fully supported yet the support members do not extend a sufficient distance over the face of the phone so as to obstruct, at least for most small phones, the left and right display regions 46L and 46R (FIG. 4) of the phone.

When a larger SmartPhone, such as the iPhone 6+® represented in phantom as 30L of FIG. 12 is used, the display apparatus support members 51R and 51L are both moved to the retracted position as depicted in the figure. FIG. 12 is also drawn approximately to scale and shows that the larger phone, which measures approximately 158 mm by 78 mm, remains fully supported by support members 51R and 51L yet the members are sufficiently spaced apart so that the left and right display regions 46L and 46R of the phone are not obscured.

In the present exemplary embodiment, the spacing intermediate cushions 58R and 58L is about 130 mm when the display apparatus support members 51R and 51L are both in the retracted positions as shown in FIG. 12. The intermediate spacing is 115 mm when the support members 51R and 51L are in the extended position as shown in FIG. 11. In the order to accommodate a fairly wide range of SmartPhones sizes, when support members 51R and 51L are moved between the retracted and extended positions it is preferred that such intermediate spacing change by at least 10 mm.

Thus, one embodiment of a stereoscopic viewing apparatus has be disclosed. Although this embodiment has been described in some detail, it should be understood that various changes can be made by those skilled in the art without departing from the spirit and scope of the invention as set forth in the appended claims.

What is claimed is:

1. A stereoscopic viewing apparatus comprising:
a housing including a left side interior portion and a right side interior portion ;
a left optical lens secured within the left side interior portion of housing which defines a left optical path along a principle axis of the left optical lens;
a right optical lens secured within the right side interior portion of housing which defines a right optical path along a principle axis of the right optical lens;
a support apparatus configured to secure a display apparatus with respect to the housing so that a left image region of the display apparatus is disposed along the left optical path and so that a right image region of the display apparatus is disposed along the right optical path, with said support apparatus including
a left support member disposed in the left side interior potion of the housing and movable between a retracted position and an extended position displaced from the retracted position in a direction towards the right hand interior portion of the housing;
and right support member disposed in the right interior portion of the housing and movable between a retracted position and an extended position displaced from the retracted position in a direction towards the left interior portion of the housing
with the left and right support members being configured so that a spacing between the left and right support members changes by at least 10 mm when the left and right support members are both moved between the extended and the retracted positions.

2. The stereoscopic viewing apparatus of claim 1 wherein the support apparatus is configured to be limited to four stable states consisting of the left support member in the retracted and extended positions and the right support member in the retracted and extended positions.

3. The stereoscopic viewing apparatus of claim 2 wherein the left support member includes a left membrane secured relative to the housing and which is pivotable about first and second spaced-apart locations, with a distance between the first and second locations along the left membrane being greater than a direct line distance between the first and second locations and
wherein the right support member includes a right membrane secured relative to the housing and which is pivotable about third and fourth spaced-apart locations, with a distance between the third and fourth locations along the right membrane being greater than a direct line distance between the third and fourth locations.

4. The stereoscopic viewing apparatus of claim 3 wherein the left membrane has a reduced cross-sectional area at the first and second locations as compared to a cross-sectional area of the left membrane at a location intermediate the first and second locations so as to facilitate left membrane bending at the first and second locations and wherein the right membrane has a reduced cross-sectional area at the third and fourth locations as compared to a cross-sectional area of the right membrane at a location intermediate the third and fourth locations so as to facilitate right membrane bending at the third and fourth locations.

5. The stereoscopic viewing apparatus of claim 4 wherein the left membrane defines a “V” shaped groove at the first and second locations so as to provide the reduced cross-sectional areas at the first and second locations and wherein the right membrane defines a “V” shaped groove at the third and fourth locations so as to provide the reduced cross-sectional areas at the third and fourth locations.

6. The stereoscopic viewing apparatus of claim 5 wherein the “V” shaped grooves extend through a majority of a thickness of the left and right membranes.

7. The stereoscopic viewing apparatus of claim 6 wherein the left and right membranes are disposed adjacent the housing when the left and right support members are in the respective retracted positions.

8. The stereoscopic viewing apparatus of claim 4 wherein the left and right membranes each include a plastic sheet comprising a central portion disposed intermediate opposite mounting portions and wherein the plastic sheet of the left membrane is secured to a housing wall of the left side interior portion of the housing only by way of the opposite mounting portions of the left membrane plastic sheet and wherein the plastic sheet of the right membrane is secured to a housing wall of the right side interior portion of the housing only by way of the opposite mounting portions of the right membrane plastic sheet.

9. The stereoscopic viewing apparatus of claim 8 wherein the reduced cross-sectional areas of the left and right membranes are located at an interface between the mounting portions and the central portions of each of the plastic sheets.

10. The stereoscopic viewing apparatus of claim 9 wherein the “V” shaped grooves are formed in the plastic sheets to create the reduced cross-sectional areas.

11. A stereoscopic viewing apparatus comprising:
a housing including a left side interior portion and a right side interior portion ;
a left optical lens secured within the left side interior portion of housing which defines a left optical path along a principle axis of the left optical lens;
a right optical lens secured within the right side interior portion of housing which defines a right optical path along a principle axis of the right optical lens;
a support apparatus configured to secure a display apparatus with respect to the housing so that a left image region of the display apparatus is disposed along the left optical path and so that a right image region of the display apparatus is disposed along the right optical path, with said support apparatus including
a left support member supported on the housing and movable between a stable retracted position and a stable displaced position in a direction towards the right side interior portion of the housing, with the left support member being unstable when disposed intermediate the retracted and displaced positions; and
a right support member supported on the housing and movable between a stable retracted position and a stable displaced position in a direction towards the left side interior portion of the housing, with the right side support member being unstable when disposed intermediate the retracted and displaced positions.

12. A stereoscopic viewing apparatus of claim 11 wherein the left support member includes a left flexible membrane secured relative to the housing and which is pivotable about first and second spaced-apart locations, with a distance between the first and second locations along the left membrane being greater than a direct line distance between the first and second locations and
wherein the right support member includes a right flexible membrane secured relative to the housing and which is pivotable about third and fourth spaced-apart locations, with a distance between the third and fourth locations along the right membrane being greater than a direct line distance between the third and fourth locations.

13. The stereoscopic viewing apparatus of claim 12 wherein the left membrane has a reduced cross-sectional area at the first and second locations as compared to a cross-sectional area of the left membrane at a location intermediate the first and second locations so as to facilitate membrane bending at the first and second locations and wherein the right membrane has a reduced cross-sectional area at the third and fourth locations as compared to a cross-sectional area of the right membrane at a location intermediate the third and fourth so as to facilitate membrane bending at the third and fourth locations.

14. The stereoscopic viewing apparatus of claim 13 wherein the left membrane defines a “V” shaped groove at the first and second locations so as to provide the reduced cross-sectional areas at the first and second locations and wherein the right membrane defines a “V” shaped groove at the third and fourth locations so as to provide the reduced cross-sectional areas at the third and fourth locations.

15. The stereoscopic viewing apparatus of claim 14 wherein the “V” shaped grooves extend through a majority of a thickness of the left and right membranes.

16. A stereoscopic viewing apparatus comprising:
a housing including a left side interior portion and a right side interior portion;
a left optical lens secured within the left side interior portion of housing which defines a left optical path along a principle axis of the left optical lens;
a right optical lens secured within the right side interior portion of housing which defines a right optical path along a principle axis of the right optical lens;
a support apparatus configured to secure a display apparatus with respect to the housing so that a left image region of the display apparatus is disposed along the left optical path and so that a right image region of the display apparatus is disposed along the right optical path, with said support apparatus including
a left flexible membrane movable between a retracted position and a displaced position located in a direction towards the right side interior portion of the housing, with the left flexible membrane being pivotable about first and second spaced-apart locations, with a distance between the first and second locations along the left flexible membrane being greater than a direct line distance between the first and second locations and
a right flexible membrane movable between a retracted position and a displaced position in a direction towards the left side interior portion of the housing, with the right flexible membrane being pivotable about third and fourth spaced-apart locations, with a distance between the third and fourth locations along the right flexible membrane being greater than a direct line distance between the third and fourth locations.

17. The stereoscopic viewing apparatus of claim 16 wherein the support apparatus is configured so that the left flexible membrane is stable in the retracted and extended positions and unstable in positions intermediate the retracted and extended positions and so that the right flexible membrane is stable in the retracted and extended positions and unstable in positions intermediate the retracted and extended positions.

18. The stereoscopic viewing apparatus of claim 17 wherein the left flexible membrane has a reduced cross-sectional area at the first and second locations as compared to a cross-sectional area of the left flexible membrane at a location intermediate the first and second locations so as to facilitate membrane bending at the first and second locations and wherein the right flexible membrane has a reduced cross-sectional area at the third and fourth locations as compared to a cross-sectional area of the right flexible membrane at a location intermediate the third and fourth so as to facilitate membrane bending at the third and fourth locations.

19. The stereoscopic viewing apparatus of claim 18 wherein the left flexible membrane defines a “V” shaped groove at the first and second locations so as to provide the reduced cross-sectional areas at the first and second locations and wherein the right flexible membrane defines a “V” shaped groove at the third and fourth locations so as to provide the reduced cross-sectional areas at the third and fourth locations.

20. The stereoscopic viewing apparatus of claim 19 wherein the “V” shaped grooves extend through a majority of a thickness of the left and right membranes.

21. The stereoscopic viewing apparatus of claim 20 wherein the left and right flexible membranes are disposed adjacent the housing when the left and right flexible membranes are in the respective retracted positions.

22. The stereoscopic viewing apparatus of claim 21 wherein the left and right flexible membranes each include a plastic sheet comprising a central portion disposed intermediate opposite mounting portions and wherein the plastic sheet of the left flexible membrane is secured to a housing wall of the left side interior portion of the housing only by way of the opposite mounting portions of the left flexible membrane plastic sheet and wherein the plastic sheet of the right membrane is secured to a housing wall of the right side interior portion of the housing only by way of the opposite mounting portions of the right flexible membrane plastic sheet.

23. The stereoscopic viewing apparatus of claim 22 wherein the reduced cross-sectional areas of the left and right flexible membranes are located at an interface between the mounting portions and the central portions of each of the plastic sheets and wherein the “V” shaped grooves are formed in the plastic sheets to create the reduced cross-sectional areas.
